(19) United States
(12) Patent Application Publication
(10) Pub. No.: US 2007/0067552 A1
(43) Pub. Date: Mar. 22, 2007

(54) Monolithic digital audio bus switch with output control

(75) Inventor: Todd Allen Toporski, Northville, MI (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/211,015

(22) Filed: Aug. 25, 2005

(51) Int. Cl. G06F 13/00

(52) U.S. Cl. 710/316

(57) ABSTRACT

A monolithic audio bus switch with simple logic control. The switch is a monolithic solution that may be controlled and operate from multiple common input voltage levels.

### FIELD OF THE INVENTION

The present invention is related to Digital Audio Bus Switches, and to 3-bit bus switches in general.

### BACKGROUND OF THE INVENTION

Today's radios & AV receivers have increased requirements for supporting multiple audio sources, most of which have digital interfaces. Compared to several years ago, there are many more audio sources available today that must be supported.

Excluding SPDIF & TDM, most common digital audio buses found in consumer audio consist of a 3-wire serial interface that includes a bit clock (BCLK), serial data (SDAT), and word/channel clock (WS). IIS, Left-justified, and Right-justified are audio interface formats that fall into this category of 3-wire serial audio bus. With the increase in digital audio sources, there is a growing need to provide more switching/muxing capability to allow for multiple audio sources to be routed to a DSP or other audio processor. Most audio processors have a limited number of digital audio bus interfaces, anywhere in the 3-5 range. Adding audio bus inputs adds pins and cost to audio processors, so it is desired to minimize inputs and control bus routing external to the processor. The ability to externally switch between many different audio sources allows the audio designer flexibility in configuring his system in multiple ways using the same audio processor.

Consider Table 1 below which shows many of the digital audio sources supported on today's radios and AV receivers.

TABLE 1
DIGITAL AUDIO SOURCES IN RADIOS & RECEIVERS

| | Minimum # | | |
|---|---|---|---|
| | of 3-bit | Typical | Max BLCK |
| | buses required | Sample Rate | Speed |
| Audio Source | (IIS assumed) | (Fs in KHz) | (MHz) |
| CD | 1 | 44.1 | 2.8224 |
| DVD | 3 | 96 | 6.144 |
| DVD audio | 3 | 192 | 12.288 |
| MP3 decoder (flash card) | 1 | 44.1 | 2.8224 |
| MP3 decoder (HDD) | 1 | 44.1 | 2.8224 |
| Satellite Radio | 1 | 32/44.1 | 2.8224 |
| HD Radio | 1 | 44.1 | 2.8224 |
| Voice (Mic/Phone) | 1 | 11.025, 16, | 1.4112 |
| | | 22.05 | |

In all systems, at least one of these sources will have to be selected at any given time. Many newer systems require selecting two or more sources at a time. Examples include: multiple headphone system that allows a different audio source to be selected for each headphone; multiple audio zones in a house or automobile, where each zone can select their own audio source; and ripping audio (MP3/WMA) while listening to something else on your portable player.

Audio designers typically use one of two methods to deal with this problem today. The first method involves using multiple discrete logic muxes, such as a 74HCT153 or 74LVC257, to provide switching capability for multiple inputs. The problem with this approach is that there aren't any devices targeted at 3-wire or 3-bit buses, and so designers use other devices that aren't optimized for the application. It typically takes several devices (4 for a 4:2 mux, or 9 for a 6:3) to implement the correct functionality.

The schematic in FIG. 1 shows an example of a 4:2 mux using discrete logic. While the cost of each device is relatively cheap, the combination of devices increases cost and consumes board space. Several control lines from a host processor are typically required, and high-speed audio clocks and data must be routed to every device which becomes a concern for signal integrity and EMC.

The second method involves using a programmable logic device, such as a CPLD or FPGA, to provide the muxing capability. While these devices offer more flexibility, they are usually expensive and can impose extra cost on the design since the devices will need to be programmed prior to assembly. FPGA's can also require additional power rails, which adds more cost to the power supply. This approach makes sense if there is a lot of extra glue logic to be reduced on the board in addition to the audio bus switching.

What is needed is a low-cost, low-power, monolithic solution to address the problem of switching 3-bit audio buses in today's audio applications. Such a device should be controllable via an I2C interface, much like the other audio IC's in the system, in order to reduce control signals, where I2C register values would control the routing of inputs to outputs. The device should have 3-bit bus interfaces on the input and output, allow for any of the inputs to be switched to any of the outputs, and accept the most common input voltage levels: 3.3 V and 5 V.

### SUMMARY OF INVENTION

The present invention achieves technical advantages as an audio bus switch with simple logic control. The switch is a monolithic solution that may be controlled and operate from multiple common input voltage levels.

### BRIEF DESCRIPTION OF THE DRAWINGS

FIG. 1 is an electrical block diagram of a prior art Digital Audio Mux;

FIG. 2 is a block diagram of a bus switch according to one preferred embodiment of the invention;

FIG. 3 is a pin diagram of the 3:1 bus switch;

FIG. 4 is a block diagram of a 4:2 bus switch;

FIG. 5 is a pin diagram of the 4:2 bus switch:

FIG. 6 depicts I2C Control Registers for the 4:2 bus switch; and

FIG. 7 is a block diagram of a receiver incorporating the present invention.

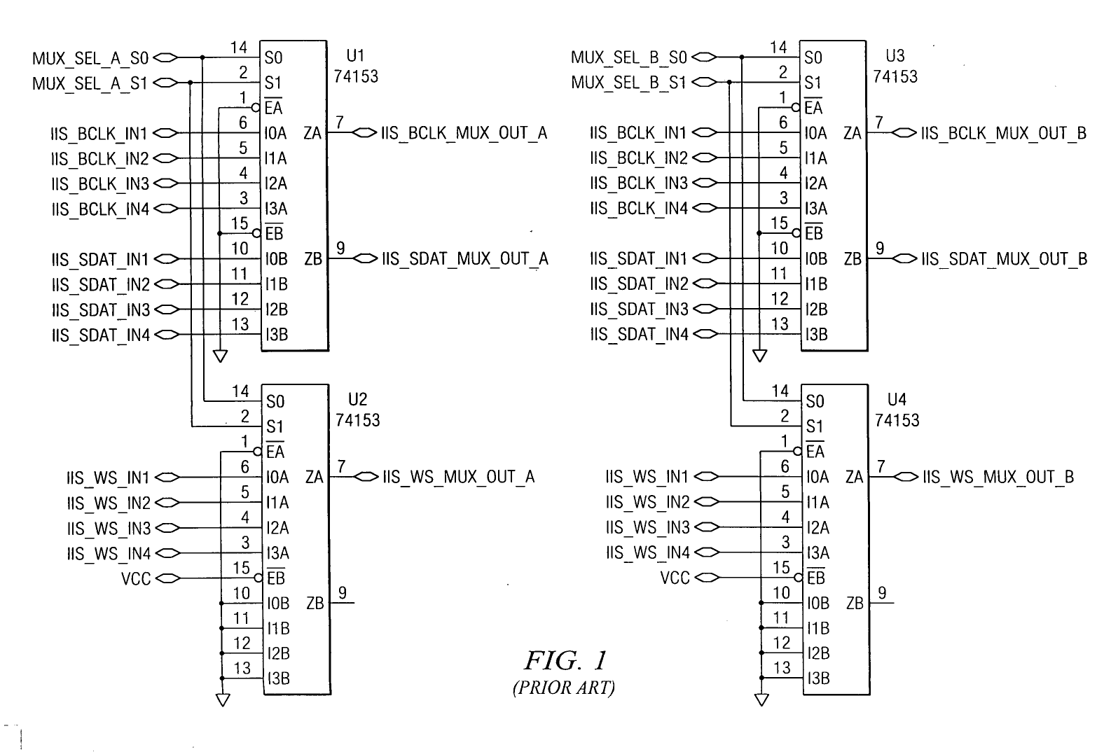

### DETAILED DESCRIPTION OF THE PRESENT INVENTION

Two preferred embodiments of the invention. The first preferred embodiment is shown as 3:1 3-bit bus switch with simple logic control. The second preferred embodiment is slightly more complex, shown as 4:2 bus switch with a I2C interface that can output any of four inputs on either of the two outputs. The invention is extremely useful in present & future audio applications.

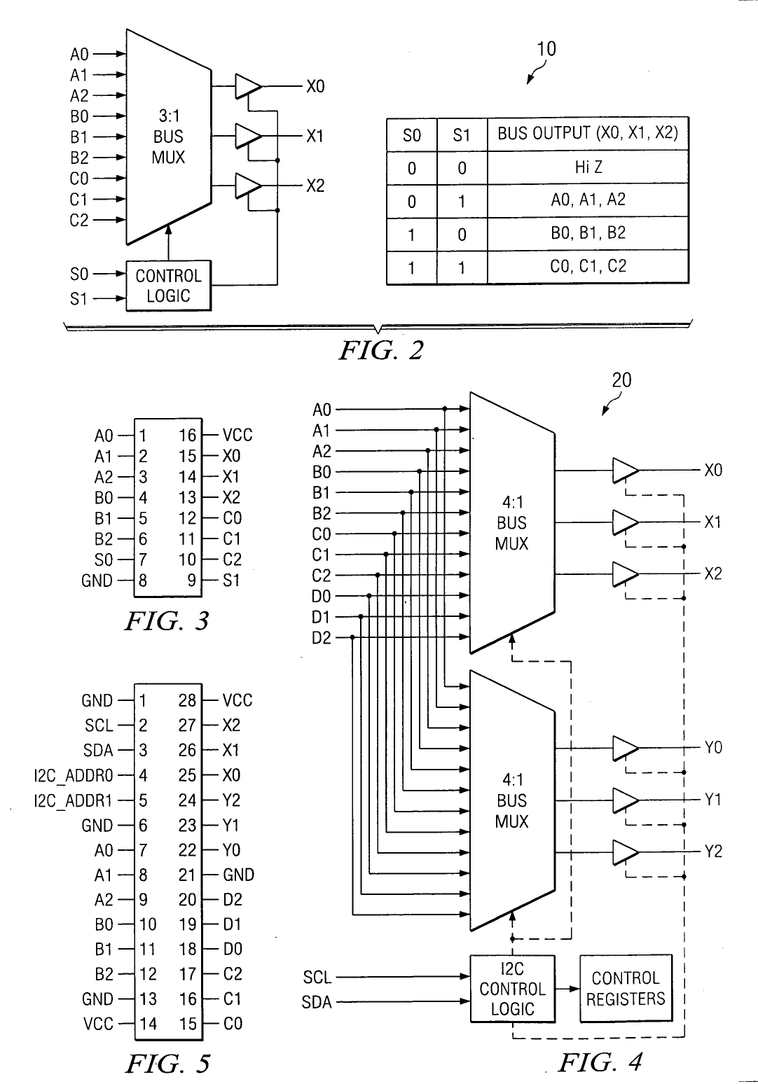

FIG. 2 shows a device block diagram for the first preferred embodiment of the invention seen to comprise 3:1 bus switch 10, and FIG. 3 shows a pinout of switch 10. The switch 10 is shown as a 16-pin device in TSSOP or SOIC package, and operates from a 3.3 V supply. Switch 10 accepts three 3-bit bus inputs (3.3 V and 5 V levels), and drives one 3-bit bus output. The switch 10 is controlled via two control logic control signals (S0, S1) provided by control logic. The control logic for these muxes is preferably digital, but the actual muxes (switches) can be implemented using digital logic or analog switches (such as MOSFET) having low on-state resistance. The switch 10 may also use I2C instead of the control signals. These 3-bit bus switches could potentially be used in other applications switching other types of serial buses, such as SPI (Serial Peripheral Interface).

FIG. 4 shows a device block diagram of a switch 20 according to a second preferred embodiment of the invention, shown as a 4:2 bus switch, and FIG. 5 shows a pinout of switch 20. The switch 20 is shown as a 28-pin device in TSSOP or SOIC package, and operates from a 3.3 V supply. Switch 20 accepts four 3-bit bus inputs (3.3 V and 5 V levels), and drives two 3-bit bus outputs. The switch 20 is controlled via I2C bus and has two I2C registers. Switch 20 also provides pins for I2C address so that multiple devices (up to four) can be used in a system on the same I2C bus.

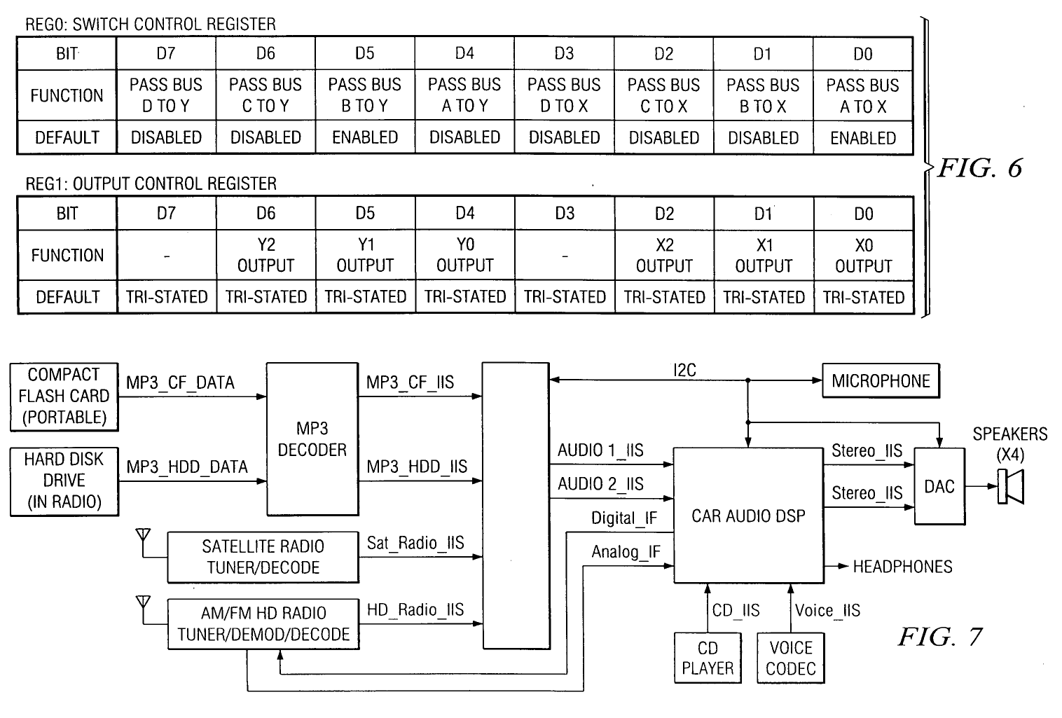

FIG. 6 shows the control registers for the switch 20 comprising a 4:2 device, which control registers are programmable via I2C. Reg0 is a control register for the internal mux blocks. Reg1 is a control register for controlling the individual output bus signals (X0, X1, X2, Y0, Y1, Y2). Advantageously, for this switch 20, each individual output can be turned on or tri-stated. In the event of multiple audio buses having the same BCLK or WS, this feature can limit redundant signals from being driven, which may help reduce EMC noise. This feature is also useful during the design phase for debugging EMC board layout issues, since each individual signal can be tri-stated and its noise contribution measured.

FIG. 7 shows one system diagram of how the 4:2 switch 20 could be used in an audio application example, such as a radio receiver with CD player & MP3 playback.

The advantages and differentiating features that make these switches of the present invention better than today's existing solutions are:

1) A monolithic integrated circuit targeted at switching 3-bit buses, such as digital audio IIS. In one embodiment, the 3:1 bus switch 10 selects one of three inputs; in the other embodiment, the 4:2 bus switch 20 can output any of four inputs on either of the two outputs.

2) Reduction in number of control pins needed by the host controller.

3) I2C interface and registers to simplify control by the host controller (on 4:2 bus switch).

4) Reduced routing of clocks and signals on PCB, which is huge improvement over discrete logic, or “glue logic” solution.

5) Optimized use of input and output pins for the application, unlike existing discrete logic solutions.

6) Ability to tri-state any of the individual bus output signals that are redundant or aren't necessary, in order to reduce power to IC, and reduce EMC and switching noise (on 4:2 bus switch 20).

7) Eliminates need for multiple discrete logic devices.

8) Available at lower cost than programmable logic.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications.

What is claimed is:

1. A monolithic audio bus controller, comprising:
a plurality of inputs each configured to serially receive audio signals from digital audio buses of a 3-wire interface;
a clock input configured to receive a bit clock (BCLK);
a word/channel clock input (WS);
a control input configured to receive control signals; and
audio switching circuitry configured to selectively switch any of the received signals to one or more outputs as a function of the control signals.

2. The controller as specified in claim 1 wherein the bus controller is configured to operate from different voltage levels.

3. The controller as specified in claim 1 wherein the bus controller is configured to operate from both a 3.3 volt DC and a 5 volt DC supply.

4. The controller as specified in claim 1 wherein the inputs are configured to serially receive audio signals in a IIS format.

5. The controller as specified in claim 1 wherein the inputs are configured to serially receive audio signals in a left-justified format.

6. The controller as specified in claim 1 wherein the inputs are configured to serially receive audio signals in a right-justified format.

7. The controller as specified in claim 1 wherein the controller comprises a switch.

8. The controller as specified in claim 1 wherein the switch is a 3:1 3-bit bus switch.

9. The controller as specified in claim 1 wherein the switch is a 4:2 3-bit bus switch.

10. The controller as specified in claim 1 wherein the control inputs comprise control registers.

11. The controller as specified in claim 1 wherein the control registers which are configured to be programmable via I2C.

12. The controller as specified in claim 1 wherein the switching circuitry is configured to output the audio signals as tri-stated.
